(19) United States
(12) Patent Application Publication
(10) Pub. No.: US 2022/0096991 A1
(43) Pub. Date: Mar. 31, 2022

(54) Composite Materials Containing Alkyl-Aryl Amine Rich Molecules and Mesoporous Supports for Direct Air CO2 Capture

(71) Applicants: Georgia Tech Research Corporation, Atlanta, GA (US); Global Thermostat, New York, NY (US)

(72) Inventors: Christopher W. Jones, Atlanta, GA (US); Dharam Raj Kumar, Atlanta, GA (US); Eric W. Ping, New York, NY (US); Cornelia Rosu, Atlanta, GA (US); Miles A. Sakwa-Novak, New York, NY (US)

(21) Appl. No.: 17/338,064

(22) Filed: Jun. 3, 2021

Related U.S. Application Data
(60) Provisional application No. 63/034,243, filed on Jun. 3, 2020.

(51) Int. Cl. B01D 53/02; B01J 20/22; B01J 20/32

(52) U.S. Cl. CPC B01D 53/02; B01J 20/22; B01J 20/3204; B01D 2258/06; B01D 2253/20; B01D 2253/25; B01D 2257/504

(57) ABSTRACT

The present disclosure provides for alkyl-aryl amine rich molecules impregnated into various porous substrates were examined for potential use as sorbents for CO₂ capture from dilute and ultra-dilute gas streams such as flue gas and ambient air, respectively.

### SUMMARY

This study describes the use of alkyl-aryl amine reach molecules (Ph-XX-YY) as sorbents for capturing CO₂ from dilute and ultra-dilute mixtures. These amines were impregnated into solid supports of various chemical compositions such as SBA-15, and y-alumina. The organic loading of the composite Ph-XX-YY-based supports was in the 20%-60% mass range. In the case of each substrate, the high amine-loading samples (50%-60%) adsorbed the largest amount of CO₂ (using 400 ppm streams, at 35° C.). For example, the CO₂ adsorption capacity of 60% Ph-3-ED/SBA-15 was 1.9 mmol CO₂/g_{SiO2}, those of 50% Ph-3-PD/SBA-15 and 50% Ph-6-ED/SBA-15 were 1.23 mmol CO₂/g_{SiO2} and 0.8 mmol CO₂/g_{SiO2}, while that of 50% Ph-6-PD/SBA-15 was 0.59 mmol CO₂/g_{SiO2}. The 50% Ph-3-PD/SBA-15 material exhibited the highest amine efficiency, 0.1 mmol CO₂/mmol N. Intermediate organic loading (aka 40%) gave better performance in terms of amine efficiency: 0.13 versus 0.11 mmol CO₂/mmol N for Ph-3-ED/SBA-15 (40%, 50%), 0.077 versus 0.048 mmol CO₂/mmol N for Ph-6-ED/SBA-15 (40%, 50%). Interestingly, in the case of Ph-6-PD/SBA-15 the amine efficiency flattened to an average value of 0.04 mmol CO₂/mmol N. Overall, the Ph-3-YY/SBA-15 composites showed a higher CO₂ uptake performance than the Ph-6-YY/SBA-15 homologues. This trend was also evident from the shape of the kinetic adsorption curves. These curves consisted of two distinct regions: one abruptly linear corresponding to the initial uptake that ‘curved’ to the other almost flat, referred to as the pseudo-equilibrium region, which asymptotically approaches the true equilibrium uptake. The highly concentrated samples approached the asymptotic regime of the curve the fastest, behavior associated with their fastest CO₂ uptake. The pseudo-equilibrium region was then more drawn out, approaching the true equilibrium more gradually. The exception was the 50% and 40% Ph-6-ED/SBA-15 samples that displayed slower kinetic behavior than the intermediate and low concentration ones in the initial linear regime. These data together suggest that the bulky molecular geometry of Ph-6-YY may hamper Ph-6-YY/SBA-15 composites from performing similarly to the Ph-3-YY/SBA-15 counterparts, despite their higher amine content. In addition, their packing at the pore walls and within the supports together with the confinement characteristics adds to the complex landscape of interactions that govern the properties of these materials.

In order to examine the effect of the solid substrate on CO₂ adsorption performance, a 50% Ph-3-ED/γ-Al₂O₃ composite was prepared. After TGA and N₂ physisorption measurements confirmed successful impregnation of Ph-3-ED, the measured CO₂ adsorption capacity was 1.54 mmol CO₂/g_{y}-Al₂O₃ and the amine efficiency was 0.11 mmol CO₂/mmol N. The CO₂ uptake of this sample was higher than that of the similarly concentrated samples (50%) prepared using the SBA-15 support.

Because the high organic loading samples were the best performers in terms of CO₂ uptake, they were further subjected to temperature-swing adsorption-desorption cycles and accelerated oxidation treatments. After 25 cycles of 1 h adsorption of 400 ppm CO₂ (35° C.) followed by 10 min desorption in He (90° C.), 60% Ph-3-ED/SBA-15 retained up to 82% of its initial amine efficiency and 50% Ph-3-PD/SBA-15 retained 44.5% of the amine efficiency, with respect to the full uptake values recorded for 12 h of adsorption time in the absence of temperature-swing cycles. This value was lower for 50% Ph-6-ED/SBA-15 (40%) and 50% Ph-6-PD/SBA-15 (25%). One of the most important findings revealed by these experiments was the ability of all composites to maintain a stable working capacity, regardless of the trends in amine efficiency. The retained amine efficiency values were reduced when the best performing composite, Ph-3-YY/SBA-15, was exposed to 21% O₂/He for 24 h at elevated temperatures (90° C. and 110° C.). The interactions with oxygen molecules caused diminished performance: only 39% (50% Ph-3-ED/SBA-15) and 20% (50% Ph-3-PD/SBA-15) of the original amine efficiencies were retained at 90° C. At 110° C. the values were 20% and 13%, respectively. These data confirm the idea that a bulky molecular architecture of Ph-6-YY did not favor high CO₂ adsorption performance. The effect of moisture on CO₂ performance was investigated by using a custom-built fixed bed setup. 60% Ph-3-ED/SBA-15 displayed double breakthrough time and three-fold increase in CO₂ adsorption capacity at 30% RH (35° C., 400 ppm CO₂) when compared with the dry conditions (0% RH)._{[KDR1]} Given their demonstrated properties, Ph-3-YY/SBA-15 composites, especially Ph-3-YY/SBA-15, are promising materials that can be potentially integrated into the DAC and other CO₂ adsorption technologies.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1: Drawing of alkyl-aryl amine rich molecules (Ph-XX-YY), 1a. Ph-3-ED, 1b. Ph-3-PD, 1c. Ph-6-ED, Id. Ph-6-PD. Ph-XX-YY abbreviation means: Ph—phenyl moiety, XX—degree of substitutions of phenyl ring (3 or 6) and YY—diamine substituents, ED (ethylene diamine) and PD (propane-1,3-diamine).

FIG. 2. CO₂ capacity recorded for Ph-3-ED/SBA-15, Ph-3-PD/SBA-15, Ph-6-ED/SBA-15 and Ph-6-PD/SBA-15 as a function of (a) organic and (b) amine loading at 35° C. under dry 400 ppm CO₂/He exposure conditions.

FIG. 3. Amine efficiencies as a function of (a) organic and (b) amine loading evaluated for Ph-3-ED/SBA-15, Ph-3-PD/SBA-15, Ph-6-ED/SBA-15 and Ph-6-PD/SBA-15.

FIG. 4. (a) CO₂ capacity (b) amine efficiency for Ph-3-ED/SBA-15, Ph-3-PD/SBA-15, Ph-6-ED/SBA-15, and Ph-6-PD/SBA-15 as a function of pore filling.

FIG. 5. CO₂ uptake profiles for Ph-3-ED/SBA-15 (a), Ph-3-PD/SBA-15 (b), Ph-6-ED/SBA-15 (c) and Ph-6-PD/SBA-15 (d). Adsorption conditions: 35° C. and 400 ppm CO₂/He.

FIG. 6: Comparison of normalized dynamic CO₂ uptake profiles for 50% Ph-3-ED/SBA-15, Ph-3-PD/SBA-15, Ph-6-ED/SBA-15 and Ph-6-PD/SBA-15 Adsorption conditions: 35° C. for 12 h under 400 ppm CO₂/He.

FIG. 7. CO₂ adsorption/desorption working capacity profile for the (a) 60% Ph-3-ED/SBA-15 and (b) 50% Ph-3-PD/SBA-15 (c) 50% Ph-6-ED/SBA-15 and (d) 50% Ph-6-PD/SBA-15 samples over 25 consecutive temperature-swing adsorption cycles. Adsorption was performed in 400 ppm CO₂/He at 35° C., desorption was performed in UHP He at 90° C. for 10 min.

FIG. 8. (a) CO₂ adsorption capacity and (b) amine efficiencies calculated from the temperature-swing adsorption profiles for Ph-3-ED/SBA-15, Ph-3-PD/SBA-15, Ph-6-ED/SBA-15 and Ph-6-PD/SBA-15.

FIG. 9. Mass change recorded during 24 h exposure to 21% O₂/He at 110 and 90° C. followed by 12 h exposure to 400 ppm CO₂ at 35° C. for (a) 50% Ph-3-ED/SBA-15 and (b) 50% Ph-3-PD/SBA-15.

FIG. 10. Comparison of CO₂ uptake profiles for 50% Ph-3-ED/γ-Al₂O₃ and 60% Ph-3-ED/SBA-15. Adsorption conditions: 35° C. and 400 ppm CO₂/He.

FIG. 11. Breakthrough curves for the 60% Ph-3-ED/SBA-15 sorbent under dry and humid (30% RH) conditions. CO₂ adsorption conditions: 400 ppm CO₂/HE, 90 mL/min flow rate, 35° C.

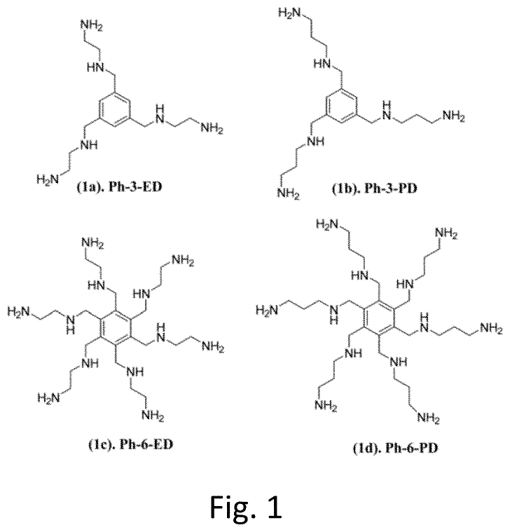

### BACKGROUND

The increase of atmospheric CO₂ concentration has alarming implications for global climate change. Intense efforts have been dedicated to develop effective technologies for carbon capture and sequestration (CCS), with a recently recognized new approach the facilitation of CO₂ from the atmosphere.¹ Direct air capture of CO₂ (DAC) from the atmosphere has been recently developed as a potential negative emissions technology (NET) due to its technological, scalability and environmental advantages.²⁻⁵ One of the benchmark technologies used in CO₂ capture is adsorption by amine-based aqueous solutions.⁶⁻⁹ While this approach has shown good performance, energy-intensive regeneration and oxidative degradation of the amine adsorbents as well rapid corrosion of the equipment are the main disadvantages.¹⁰ Another technology explored in the last years uses solid-supported amine adsorbents, especially for their CO₂ adsorption performance at low temperature.¹¹⁻¹⁵ Based on the sorbent processing approach, these materials have been grouped into three classes. Class 1 sorbents consists of small molecules and polymeric amines that are physically confined into porous supports.^{12,13,15-20} Small molecules, usually aminosilanes, covalently bound to the inner and exterior porous support surface, form the class 2 materials.^{11,19-21-23} While the class 1 sorbents exhibit higher CO₂ adsorption capacity than the class 2 materials in many cases due to higher amine loadings, impregnated amines may be more mobile during sorbent regeneration and also may be less stable towards leaching or volatilization. Combining covalent immobilization and use of polymeric amines led to the class 3 materials.^{3,24} The process typically uses in-situ polymerization of amine-containing monomers inside the support pores and yields highly stable oligomeric and polymeric amine-rich species covalently bound to the solid's walls. Recently, new efforts have been focused on developing polymeric materials that exhibit combined properties of both solid supports and amine adsorbents.¹⁴ Nowadays, both high temperature aqueous solution-based DAC and low-temperature solid-supported sorbent DAC technologies are commercially available but the latter option promises potential for extensive cost reduction.²⁵

To reduce the process costs of solid-based DAC, innovative approaches have been devoted to improve the performance and expand the library of amine sorbents. In general, simple alkyl amine molecules or macromolecules are among the most widely employed as the class 1 sorbents. For example, Zhu et al. have used tetraethylenepentamine (TEPA) impregnated into mesoporous silica and reported a high adsorptive capacity of 183 mg/g after six adsorption-desorption cycles at low CO₂ concentration (5%) using an optimal 50% organic loading.²⁶ Recently Yamada et al. has modified the amine end group of TEPA and achieved CO₂ adsorption capacity values as high as 4.65 mmol/g, representing 0.42 mmol CO₂/mmol N in terms of amine efficiency.²⁷ This performance was achieved under flue gas conditions, using 14% CO₂, 5% O₂, 4% H₂O and balance N2 at 40° C. Desorption was performed at 60° C. for one hour by sweeping argon gas (30 mL/min). Control experiments were also conducted at 100° C., the more largely used value, but differences in desorption efficiency between the two temperatures were not significant. Complex mixtures of diamines containing TEPA were also studied by Wifong et al. in post-combustion gas mixture conditions, as reported in a recent patent.²⁸ They have disclosed that ethylenimine oligomer (EI423), TEPA, pentaethylenehexamine and hexaethyleneheptamine pelletized into silica-based supports showed a CO₂ adsorption capacity higher than 1.7 mmol/g in a 10% CO₂ stream. Good stability was displayed in the CO₂ desorption temperature range (100-110° C.).²⁸ A series of invention disclosures involving amine sorbents also report methods for capturing CO₂ from the ambient air and adsorption performances either near or similar to the values listed above.^{29 30} Perhaps the most studied and widely used amine material in solid CO₂ sorbents is poly(ethyleneimine) (PEI), due to its high content of primary and secondary amine groups. Xu et al. have developed a composite of linear PEI (50%)-mesoporous molecular sieve (MCM-41) with a CO₂ adsorption capacity as high as 215 mg/g at 75° C. and 99.8% bone-dry CO₂ introduced at a flow rate of 100 mL/min.³¹ Li et al. reported 202 mg/g adsorption capacity at 105° C. and 1 atm for 60% PEI loading under a pure CO₂ stream (60 mL/min). Additionally, the authors have conducted adsorption experiments under 15% CO₂ conditions and the sorption capacity was 132 mg/g.³² Branched PEI (10-70%) infused into a porous silica support was also investigated and the resulting composite material achieved high CO₂ sorption capacities of 4 up to 13 mol/g at 25° C., 10% CO₂ and 2% H₂O).³³ Regardless of the molecular architecture of linear versus branched, the adsorption capacity depended on the PEI molecular weight.³² Also, the desorption rate of CO₂ was markedly slower for linear PEI than for branched PEI, as was the enthalpy of CO₂ adsorption.³⁴ According to a disclosure by Eisenberger, PEI displayed good thermal stability over consecutive adsorption-desorption cycles performed in both humid and dry atmospheric CO₂ conditions, which suggested the potential for cyclic stability.³⁵ Because PEI was affected by oxidation when exposed to conditions simulating a process upset, combining high oxygen partial pressures and elevated temperatures, more oxidatively stable sorbents have been sought. For example, Wang et al. have used composite materials made by infusing SBA-15 with polyallylamine (PAA).³⁶ They have found that PAA displayed better resistance to thermal degradation than PEI-based homologues. The best CO₂ adsorption performance was achieved at 65% PAA loading (109 mg CO₂/g) at 140° C. and 10% CO₂ stream. In another study, Bali et al. reported that PAA adsorbents were more stable than branched PEI counterparts at elevated temperatures (110° C.) and high O₂ concentrations (21%) during humid oxidation conditions.³⁷ PAA-containing samples retained about 88% of their CO₂ capacity irrespective of the treatment conditions. Alkhabbaz et al. have functionalized PAA with guanidine and found that the modified PAA sorbents presented better working capacity at high temperature (120° C.) than the control PAA ones under dry 10% CO₂ conditions.³⁸ Recently, linear poly(propyleneimine), PPI, was prepared and determined to be a more oxidatively stable sorbent.¹² The PPI compounds used, ranging from 700 Da to 36,000 Da in molecular weight, were more efficient at CO₂ capture than linear PEI homologues in a 400 ppm CO₂ stream, and they retained 65-83% of their CO₂ capacity after harsh oxidative treatment.^{12,15,39} In contrast, only 20-40% retention was recorded for linear PEI under similar conditions. In addition, branched PPI prepared by ring-opening polymerization of azetidine was also found as a promising alternative to PEI-based adsorbents.¹³

To overcome limitations in CO₂ adsorption performance due to limited thermal and oxidative stability, synthesis of new solid-supported amine-rich sorbents continues.⁴⁰ It is known that thermal stability of aromatic amines and amides is higher than that of aliphatic counterparts. In line with this idea, Mane et al. synthesized a series of porous, amine-rich polymers that were thermally stable in the 300° C.-500° C. temperature range.⁴¹ The maximum CO₂ capacity recorded at 25° C. was 208.3 mg/g at 0° CO₂ bar and highly pure CO₂ stream (99.999%). For experiments performed under the same conditions but at 25° C., the adsorption capacity was as high as 164.1 mg/g.⁴¹ Puthiaraj et al. post-synthetically functionalized aromatic polymers with diethyleneamine yielding microporous porous materials that were thermally stable and showed CO₂ adsorption capacities of 216.0-231.6 mg/g at 25° C. and 1 bar CO₂.⁴² It should be noted that many of the examples cited above that appear to have high uptake capacities were tested under conditions that are not relevant to practical carbon capture, for example using pure CO₂ and/or very low temperatures. It is expected that impregnation of alkyl-aryl small molecules into various mesoporous substrates will yield composite materials that exhibit better thermal and oxidative stability than PEI, the benchmark amine polymer used in prototype DAC and post-combustion capture technologies.

### Materials and Methods.

The mesoporous silica SB A-15 or mesoporous alumina supports were functionalized with Ph-XX-yy using a wet impregnation method. In a typical synthesis process, the desired amount of Ph-XX-YY was dissolved in methanol (10 mL). In a separate round bottom flask, the SBA-15 or mesoporous alumina support material (200 mg) was added to 50 mL of methanol and stirred vigorously for 1 h. Subsequently, the Ph-XX-YY solution was added to the SBA-15/methanol suspension and the final mixture was stirred overnight at room temperature. After that, the solvent was removed using rotary evaporation and dried overnight under high vacuum. The percentage loading of the organic content in the composite was varied by using equation 1.

$$\% Loading = \frac{α}{α + β} \times 100 \qquad Equation 1$$

where α represents the mass of added Ph-XX-YY (g) and β represents the mass of SBA-15 silica support or mesoporous alumina (γ-Al₂O₃) (g).

Thermogravimetric analysis was performed on a Netzsch STA409PG TGA to determine the weight loading of amine molecules in the composite materials. Weight loss between 120° C. and 900° C. was taken to represent the organic content of the material. Overall, the evaluated mass loss percentages attributed to organic content were close to the target values used in the composite material preparation. Elemental analysis also confirmed the loading of amine molecules in the mesoporous supports. Table A1 summarizes the amount of nitrogen (N) found in each sample. As expected, the content of N increased with the increase in organic loading. The determined weight loadings correspond to roughly 0-16 mmol N per gram SBA-15.

Nitrogen physisorption isotherms at 77 K were collected on a Micromeritics Tristar 3020 instrument after being degassed for 12 h at 110° C. The BET theory was used to determine specific surface area. Pore volume was calculated based on the amount of N2 adsorbed at p/p0 Of 0.95. Pore size distribution was evaluated by the BJH method available in the MicroActive software package by Micrometries. All these values are listed in Table A1.

CO₂ adsorption capacities were determined gravimetrically by using a Q500 TGA instrument from TA Instruments. In a typical procedure, initially the materials were pretreated at 110° C. with a ramp rate of 5° C./min under inert He (90 mL/min) for 2 h. Then samples were cooled to 35° C. and equilibrated for 1 h. Subsequently, the gas flow was switched to a 400 ppm CO₂/He for 12 h and the recorded mass gain was converted to the amount of CO₂ adsorbed, and normalized by the dry mass of the sample. Table A1 summarizes the CO₂ capacity of Ph-XX-YY/SBA-15 and 50% Ph-3-ED/γ-Al₂O₃.

Accelerated oxidative measurements were performed in the same Q500 TGA instrument from TA Instruments Q500 TGA. The samples were heated at 110 or 90° C. under a flow of ultrazero grade air for 24 h. The samples were then cooled to 35° C. and equilibrated for 1 h. Subsequently, the gas flow was switched to a premixed gas containing 400 ppm CO₂/He for 12 h. The mass gain was recorded, converted to amount of CO₂ adsorbed, and normalized by the dry mass of the sample.

The 60% Ph-3-ED/SBA-15 sorbent was investigated for the effect of relative humidity (30%) using an in-house custom-built fixed bed system at 35° C. and 400 ppm CO₂ conditions. The dry and humid CO₂ capacities were determined by using an in-house made glass fritted fixed bed system previously reported by Lee et al.^{43,44} CO₂ adsorption was performed using 400 ppm CO₂ balanced with He with constant flow rate of 90 mL/min at 35° C._{[KDR2]}

### Results and Discussion

### A. Ph-XX-YY/SBA-15 Composites

### 1. CO₂ Capacity Under Dry Conditions.

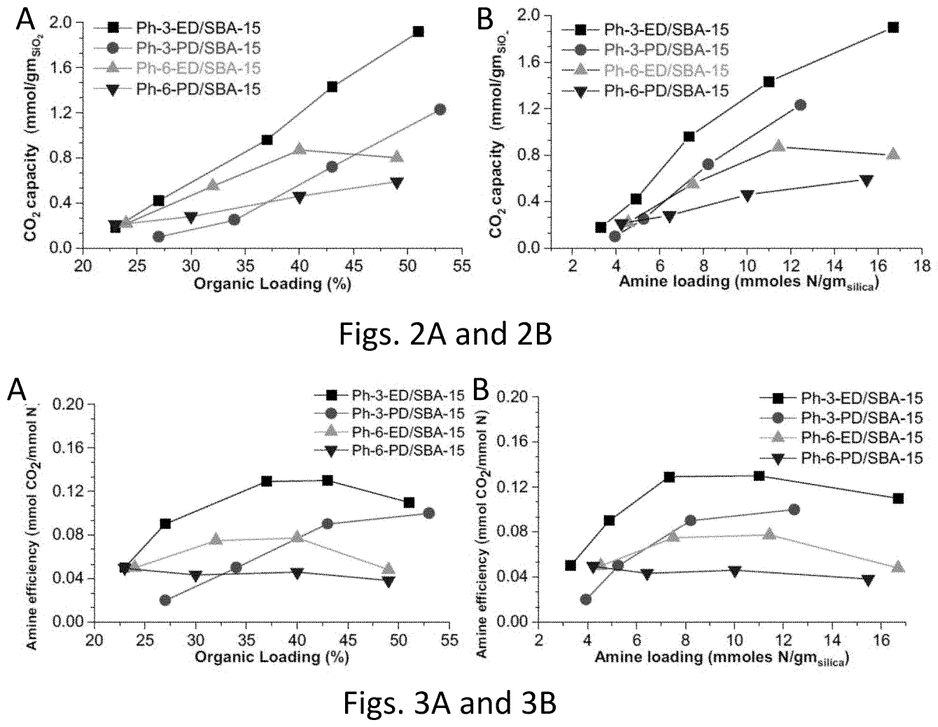

The CO₂ adsorption performance of Ph-XX-YY/SBA-15 composites under dry direct air capture conditions was investigated gravimetrically by thermogravimetric analysis (TGA). After isothermal pretreatment at 110° C. to remove adsorbed water and trace CO₂ adsorbed from the atmosphere, adsorption was performed at 35° C. for 12 h under dry 400 ppm CO₂/helium (He) conditions. As shown in FIG. 2 the CO₂ capacity increased with the organic and amine loading for all Ph-XX-YY/SBA-15 composites. Regardless of the organic loading, Ph-3-ED/SBA-15 and Ph-3-PD/SBA-15 showed superior CO₂ adsorption capacity than their Ph-6-ED/SBA-15 and Ph-6-PD/SBA-15 homologues (FIG. 2). For example at 40% loading they reached 1.43 mmol CO₂/g_{SiO2} and 1.23 mmol CO₂/g_{SiO2} versus 0.87 mmol CO₂/g_{SiO2} and 0.46 mmol CO₂/g_{SiO2}, respectively. These values were achieved at an amine loading of about 12 mmol N/g_{SiO2}. The highest uptake, 1.9 mmol CO₂/g_{SiO2}, was recorded for 60% Ph-3-ED/SBA-15 at an amine loading of 16.7 mmol N/g_{SiO2}.

### 2. Amine Efficiency

The amine efficiency values of Ph-XX-YY/SBA-15 composites were further evaluated, as shown in FIG. 3. Similarly to the CO₂ adsorption performance trend, 30% Ph-3-ED/SBA-15 displayed the highest amine efficiency, 0.13 mmol CO₂/mmol N at 7.3 mmol N/g_{SiO2} loading, a value that was essentially constant up to 40% sample at 11 mmol N/g_{SiO2} loading. Despite having the largest amount of CO₂ adsorbed, the amine efficiency of 60% Ph-3-ED/SBA-15 was only 0.11 mmol CO₂/mmol N. The 50% Ph-3-PD/SBA-15 sample had slightly lower values, 0.1 mmol CO₂/mmol N, but were higher than that of 50% Ph-6-ED/SBA-15 (0.048 mmol CO₂/mmol N) and 50% Ph-6-PD/SBA-15 (0.046 mmol CO₂/mmol N). Interestingly, 50% Ph-6-PD/SBA-15 showed a flat average value of ˜0.045 mmol CO₂/mmol N, irrespective of the amine loading. Together, the CO₂ adsorption and amine efficiency data indicate that full substitution of the aromatic ring with amine-containing arms does not favor high performance, likely due to the bulky molecular structure.

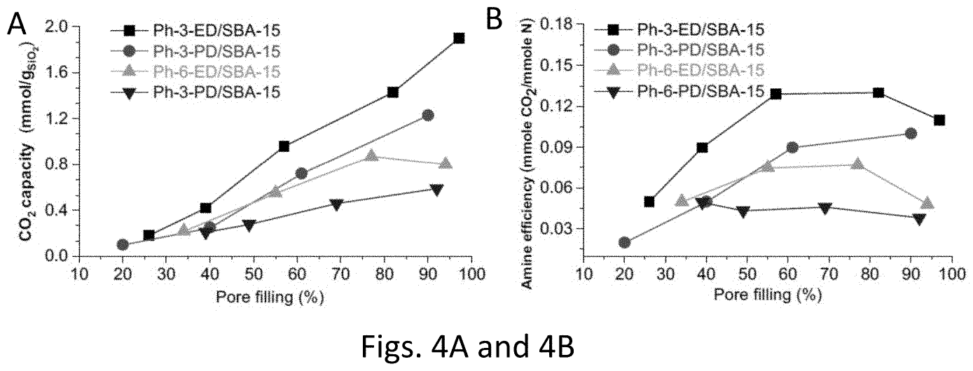

Additionally, the pore parameter analysis confirmed the influence of Ph-XX-YY molecular structure differences on CO₂ capture performance and amine efficiency. FIG. 4a shows that Ph-3ED/SBA-15 and Ph-3-PD/SBA-15 filled the pores up to 80-90% at 50% organic loading and adsorbed the largest amount of CO₂. While the pore filling values of 50% Ph-6-ED/SBA-15 and 50% Ph-6-PD/SBA-15 composites were slightly higher (≥90%), their CO₂ adsorption performance was significantly lower (FIG. 4a). The trend in amine efficiency (FIG. 4b) as a function of pore filling followed the same pattern as the CO₂ uptake profiles. Apart from this tendency and similarly to the above data displayed in FIG. 2a, Ph-6-PD/SBA-15 presented a relatively constant average value around 0.04 mmol CO₂/mmol N. Likely due to their less bulky molecular architecture, Ph-3-YY molecules have the ability to better arrange and fill the voids of the SBA-15 support. The arrangement of these molecules that may also involve their n-system⁴⁵ coupled to less steric hindrance, enabling efficient exposure of amine sites to CO₂ gas molecules. In the case of Ph-6-YY, their bulky nature most probably hinders effective CO₂ access to amine groups.

### 3. Kinetics

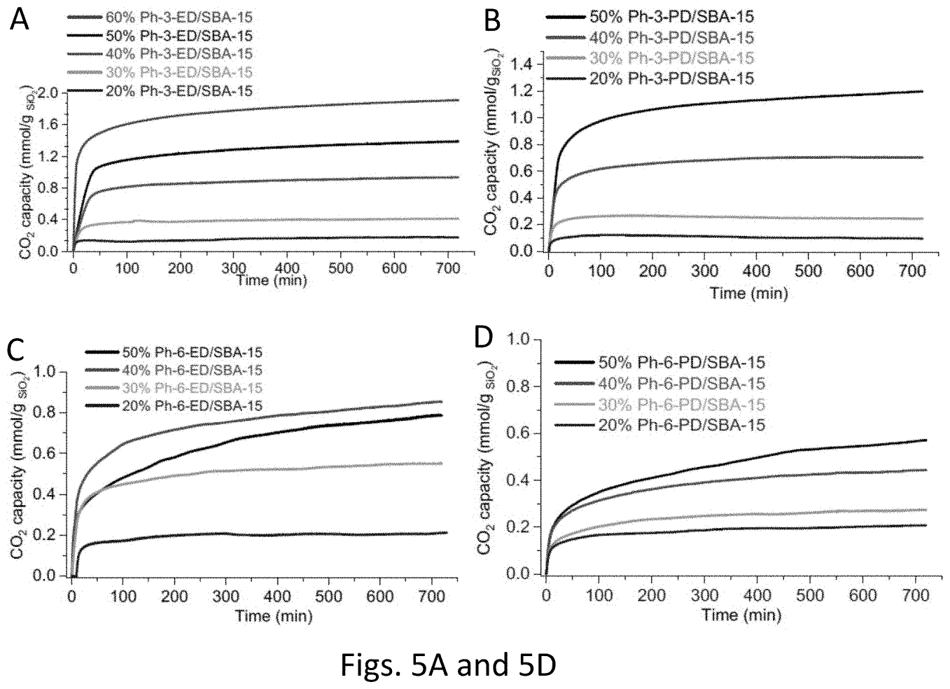

To better understand the correlation between CO₂ uptake values at pseudo-equilibrium, amine loading and time, the adsorption kinetic curves were compared, as shown in FIG. 5. For all samples the equilibrium capacities listed in Table A1 showed that the amount of CO₂ increased with the amine loading during the allocated 12 h adsorption time. The curves displayed an initial linear and fast approach to a maximum value of CO₂ uptake that flattened to a pseudo-equilibrium capacity for low organic contents (20% and 30%). For samples with higher organic loading (40%, 50% and 60%) the curves also had a rapid initial increase, but then did not show a perfect plateau, rather presenting a slow and slight increase in CO₂ uptake with time. As a reflection of data exhibited in FIG. 2b, Ph-3-YY/SBA-15 adsorbed the largest amount of CO₂ at high organic loadings. In the low loading regime, the 30% Ph-6-ED/SBA-15 sample apparently had a slightly better performance than the 30% Ph-3-ED/SBA-15 counterpart. This trend was more evident at 20% organic loading, comparing Ph-6-YY/SBA-15 versus Ph-3-YY/SBA-15. An interesting behavior was noted for the 50% Ph-6-ED/SBA-15 sample: the linear approach to pseudoequilibrium was slower than that shown by the 40% Ph-6-ED/SBA-15 homologue. In contrast, the 60% Ph-3-ED/SBA-15 displayed the fastest kinetics. These data support the idea that the molecular structure of these two types of alkyl-aryl compounds dictates their sorption properties.

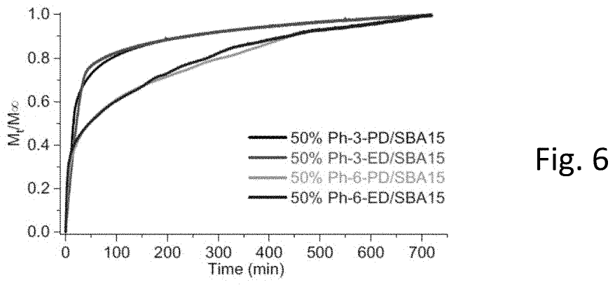

Additional evidence that the molecular architecture is another factor that can govern kinetics was obtained from plotting the normalized dynamic CO₂ uptake curves for 50% Ph-XX-YY/SBA-15 composites. The shape of the two regions comprising the kinetic curves displayed in FIG. 6 indicates that Ph-6-YY/SBA-15 samples had slower kinetic behavior than their Ph-3-YY/SBA-homologues. As also described above (FIG. 2), Ph-3-YY/SBA-15 samples were better sorbents than Ph-6-YY/SBA-15 materials. Coupling these results with the trends seen in amine efficiency as a function of amine loading (FIG. 3) and pore filling (FIG. 4) it is evident that the bulky molecular architecture of Ph-6-YY was a key feature that hampered Ph-6-YY/SBA-15 composites performance as CO₂ sorbents.

Overall, the shape of the kinetic curves demonstrates that the adsorption process reached pseudo-equilibrium in about 10 min. At low amine loadings, CO₂ molecules diffuse and form covalent and physical bonds with the amine sites. The result of these interactions is the formation of an ammonium carbamate ion. The stabilization of the carbamate adduct can create intra and intermolecular crosslinks between two amine sites. Saturation of amine sites with CO₂ at 20% and 30% organic loading most likely does not lead to strong diffusional limitations, owing to limited pore filling by the amine molecules. At high amine loadings, the packing of amine molecules at the walls, especially within the pores, and the confinement conditions within the pores, can strongly influence the rate at which CO₂ establishes contact with free amine sites, thereby establishing intra/intermolecular crosslinks. The progressive crosslinking to stabilize the carbamate adduct can limit diffusion of CO₂ through the developing network and slows down the kinetics, as shown in FIGS. 5c and 5d. Unfavorable kinetics were reported for various amine sorbents, including the benchmark poly(ethylenimine)^{16,46} and recently poly(propylenimine),^{12,15,47} and this has been suggested to be due to the agglomeration of the amine-containing organic phase in a bulk, liquid-like phase inside the pores in some studies.⁴⁸

### 4. Long-Term Working Stability

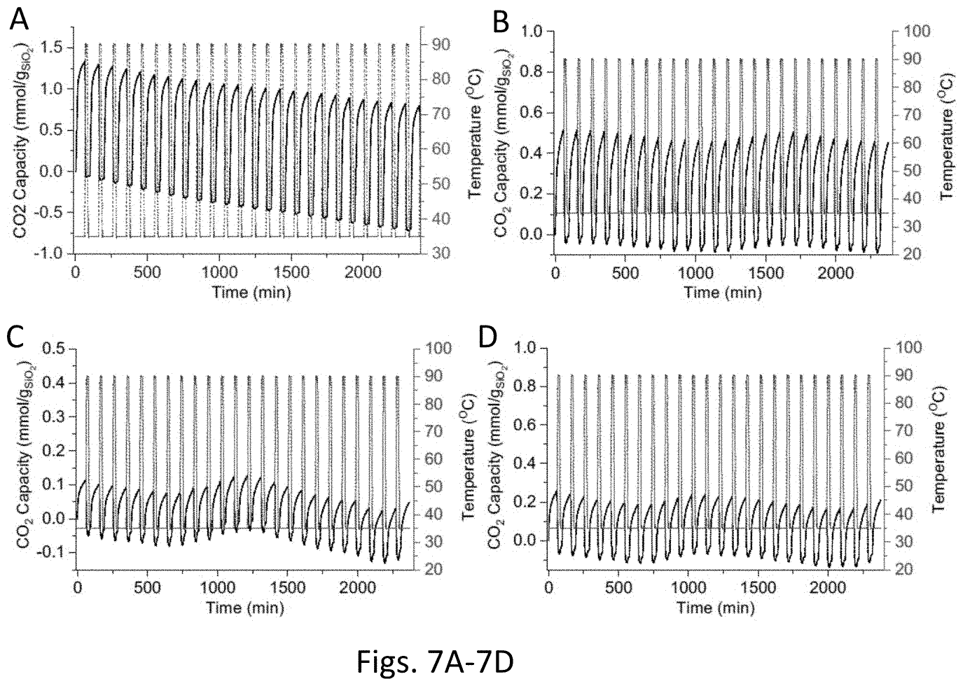

The long-term stability of the Ph-XX-YY/SBA-15 composite materials was assessed by using some of the highest loaded samples (50%) for multicycle runs, as they displayed, in general, the highest CO₂ adsorption capacities (FIG. 5). These samples were subjected to an initial pretreatment (2 h, 110° C., He) to remove adsorbed water and CO₂ traces and then to temperature-swing adsorption (1 h, 35° C., 400 ppm CO₂/He)-desorption (90° C., 10 min, He) cycles. As shown in FIG. 7, in the calculation of the CO₂ uptake the sample mass recorded after pretreatment at 110° C. for 2 h was subtracted from the mass in all subsequent cycles, allowing the plotting of the cyclic CO₂ uptake directly. This step was performed to exclude the contribution from adsorbed water and CO₂ potentially occurring during sample storage. By comparing the linear fast regime of the kinetic curves acquired during 12 h for the 60% Ph-3-ED/SBA-15 material (FIG. 5a) with the same region of the first 5-6 cycles recorded over 1 h (FIG. 7a), it can be concluded that approximately 80% of the 12 h pseudoequilibrium value was easily reached within 1 h. For the last 12-15 cycles this value slightly increased to about 85-86% (FIG. 8a). The same trend was noted for the 50% Ph-3-PD/SBA-15 sample (FIG. 7b). The Ph-6-YY-based composites had a significantly different behavior. The 50% Ph-6-ED/SBA-15 sample (FIG. 7c) reached only 25% of the pseudoequilibrium value after 1 h and this value was constant through all 25 cycles despite the somewhat ‘undulating’ pattern of the curve. After 1 h the 50% Ph-6-PD/SBA-sample (FIG. 7d) reached about 90% of the CO₂ uptake value recorded after 12 h (FIG. 5d).

Another important aspect reflected by FIG. 7 is the shape and retained performance of the temperature-swing cycles with respect to each other. The height of the adsorption profile aka the amount of adsorbed CO₂ was approximately equal during 25 cycles, regardless of the sample composition. This behavior indicates constant and stable working capacity of the Ph-XX-YY/SBA-15 composite materials. Indeed, FIG. 8 confirms these observations. The CO₂ capacity and amine efficiency values extracted from FIG. 7 demonstrate that samples maintained a stable operation. The fact that all samples displayed steady working capacity suggested that the sorbent Ph-XX-YY molecules did not deactivate during temperature-swing cycles. On the contrary, after each activation step (desorption of CO₂) performed at 90° C., the composite material was able to capture CO₂ at a constant rate. Most importantly, this study revealed that the Ph-XX-YY sorbents likely do not degrade during cycling via urea formation and do not undergo volatilization during 25 cycles of temperature-swing-cycles.

### 5. Oxidative Stability

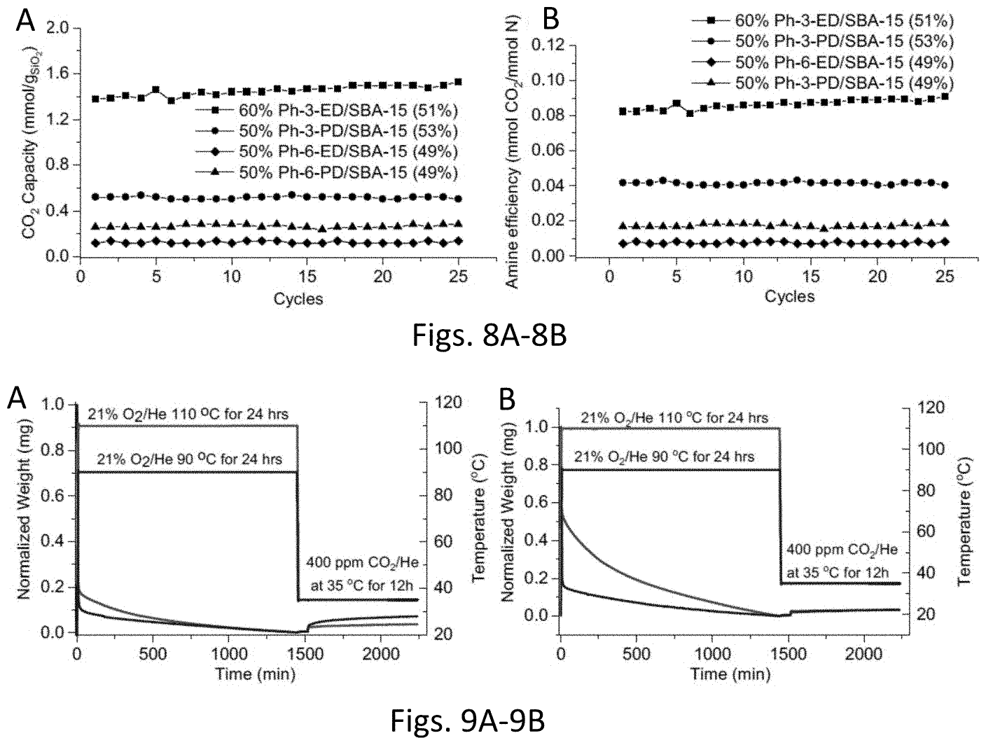

Because the working conditions did not reveal significant sorbent degradation, the best performing Ph-3-YY/SBA-15 composites were further subjected to an accelerated oxidative treatment at relatively high temperature. These experiments mimic real-life sorbent operation conditions that involve exposure to the oxygen containing air should a process upset occur combining exposure to elevated temperatures and O₂ partial pressures simultaneously. It is important to understand whether degradation under oxygen exposure occurs and also to assess the extent to which it will impact the sorbent performance. FIG. 9 displays 50% Ph-3-ED/SBA-15 and 50% Ph-3-PD/SBA-15 samples exposed for 24 h at 110° C. and 90° C. to a stream of ultrazero grade air (21% O₂/He) followed by adsorption of CO₂ (400 ppm/He) for 12 h at 35° C. Treatment at a lower temperature 90° C. was performed to be consistent with desorption steps of the temperature-swing process illustrated above in FIG. 7. The 50% Ph-3-ED/SBA-15 showed an initial abrupt mass loss, likely due to physisorbed water and CO₂ traces. After this stage, the sample mass was gradually lost during the treatment (about 8% and 5%) at both 90° C. and 110° C. Interestingly, the treatment temperature apparently had a different effect on the two samples. FIG. 9a shows that after oxidation treatment at 90° C., the 50% Ph-3-ED/SBA-15 sample comparatively adsorbed a larger amount of CO₂ than when treated at 110° C. This trend was observed despite the fact that for the last ˜30% of the oxidative treatment time the change in mass was similar at the two temperature treatment values. As listed in Table 1, the sample retained 35% of its initial CO₂ adsorption performance and 39-40% of its amine efficiency at 90° C. These numbers were a little smaller for the 110° C. oxidative treatments: 20% and 23%, respectively. On the other hand, the mass change for 50% Ph-3-PD/SBA-15 was more gradual at 90° C. than at 110° C. The CO₂ amount adsorbed was quite similar: 0.02 mmol CO₂/g_{SiO2} (90° C.) and 0.01 mmol CO₂/g_{SiO2} (110° C.). Converted to retained CO₂ uptake-amine efficiency, these values represent 22%-20% at 90° C., and 13%-10% at 110° C. Furthermore, the values can be compared to those described in the previous paragraph regarding long-time stability. After oxidative treatment at 110° C., the amine efficiency of 50% Ph-3-ED/SBA-15 was three times less than that recorded during temperature-swing cycles. Following the same trend, the 50% Ph-3-PD/SBA-15 sample performance was four times lower. These data clearly supported the idea that the structure of the sorbents greatly influences the CO₂ adsorption performance of the composite materials.

TABLE 1
CO₂ capacity and amine efficiency values calculated after accelerated oxidation conditions
and percentage of retained performance.

| | CO₂ capacity | | | Amine efficiency | | | Retained (%) | |
|---|---|---|---|---|---|---|---|---|
| | (mmol/gSiO₂) | | | (mmol CO₂/mmol N) | | | CO₂ capacity/ | |
| | Before | After oxidation | | Before | After oxidation | | Amine efficiency | |
| Composites | oxidation | 90° C. | 110° C. | oxidation | 90° C. | 110° C. | 90° C. | 110° C. |
| 50% Ph-3-ED/ | 1.43 | 0.51 | 0.3 | 0.13 | 0.05 | 0.03 | 35/39 | 20/23 |
| SBA-15 | | | | | | | | |
| 50% Ph-3-PD/ | 1.23 | 0.27 | 0.15 | 0.1 | 0.02 | 0.01 | 22/20 | 13/10 |
| SBA-15 | | | | | | | | |

B. Ph-3-ED/γ-Al₂O₃ Composites

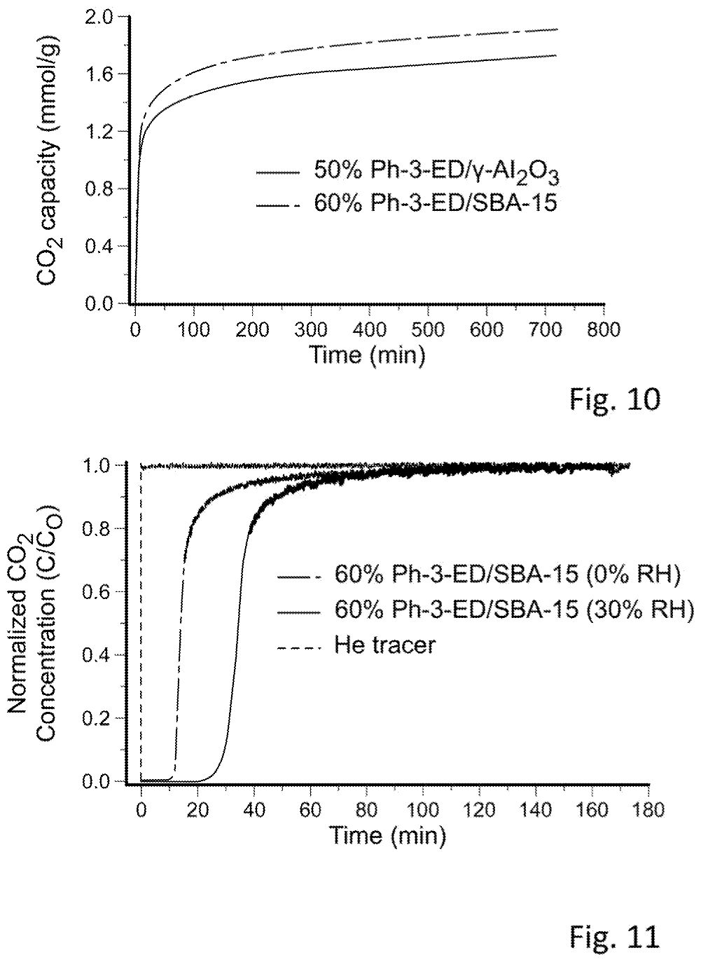

The best performing Ph-3-ED compound was also used to make a composite with γ-Al₂O₃, as the solid support, at 50% loading by wet impregnation. After the presence of the Ph-3-ED in the composite was confirmed by TGA and N2 physisorption measurements, the CO₂ capacity was studied by using 400 ppm CO₂/He at 35° C. for 12 h conditions. The 50% Ph-3-ED/γ-Al₂O₃ composite showed a capacity of 1.54 mmol CO₂/gγ-Al₂O₃ and an amine efficiency of 0.11 mmol CO₂/mmol N (Table A1). The 50% Ph-3-ED/γ-Al₂O₃ composite showed a slightly lower CO₂ adsorption capacity as compared to the 60% Ph-3-ED/SBA-15 sorbent material (FIG. 10). On the other hand, the performance of this sample was higher than that of the 50% Ph-XX-YY/SBA-15 homologues. No marked differences were noted in amine efficiencies.

### 6. Dry and Humid CO₂ Adsorption Capacity Measurement Using a Fixed Bed:

Because DAC typically consists of capturing CO₂ in the presence of substantial amounts of humidity in the air, it is essential to evaluate the effect of moisture on the CO₂ adsorbent performance. Previous studies showed that under dry conditions, the interaction between CO₂ and amines leads to formation of carbamates with a CO₂/N ratio of 0.5. On the other hand, in presence of moisture, the interaction between CO₂ molecules and amine sites can also result in the formation of bicarbonates with CO₂/N ratio of 1.⁴⁹⁻⁵¹ For example, Wang el al. demonstrated that, the CO₂ adsorption capacity and the stability of the PEI (M_{w}=600)-based adsorbent increased significantly in the presence of moisture. The adsorbent showed an increase in CO₂ adsorption capacities by 21% and 15% for CO₂ concentration of 5000 and 400 ppm, respectively, with 80% RH.⁵² In the case of 400 pm CO₂ adsorption, the amine efficiency increased from 0.18 to 0.2 mmol CO₂/mmol N (˜11%). Wang el al. suggested that the enhancement in CO₂ capacity for the 400 ppm condition is lower compared to the 5000 ppm due to competitive adsorption between CO₂ and H₂O molecules.⁵²

FIG. 11 shows that CO₂ breakthrough time increases to 22 min in the presence of 30% RH and 35° C. The breakthrough capacity (2.73 mmol CO₂/g_{SiO2}) under humid conditions was ˜3 times higher when compared to the breakthrough capacity under dry conditions (0.83 mmol CO₂/g_{SiO2}). The equilibrium CO₂ capacity increased by ˜81% from 1.6 mmol/g_{SiO2} to 2.9 mmol/g_{SiO2} with 30% relative humidity. The amine efficiency of 60% PH-3-ED/SBA-15 increased by 70% from 0.1 to 0.17 mmol CO₂/mmol N using 400 ppm CO₂ with 30% RH (Table 2). The slope of the CO₂ breakthrough curve under dry conditions, suggesting a negligible effect of water vapor at 30% RH on the CO₂ sorption kinetics.

The CO₂ capacity obtained for dry 400 ppm CO₂ conditions and using the fixed bed system was 1.6 mmol/g_{SiO2}, which is similar to the CO₂ capacity obtained from TGA (1.9 mmol/g_{SiO2}). CO₂ from the dry feed mixture breaks through the bed after 10 min and approaches saturation at approximately 150 min (FIG. 11). The equilibrium capacities of both the dry and humid runs as shown in Table 2 were measured when the outlet CO₂ concentration was 99% of the inlet feed CO₂ concentration.

TABLE 2
Comparison of CO₂ Capacity and Amine Efficiency of 60% Ph-3-
ED and 60% PEI-Based Sorbents Using TGA and Fixed Bed Adsorption
Methods Under 6% and 30% Relative Humidity.

| | Relative | Break- | | Amine |
|---|---|---|---|---|
| Sample | Humid- | through | Equilibrium | efficiency |
| [CO₂ | ity | CO₂ | CO₂ | (mmol |
| adsorption | (RH) | capacity | Capacity | CO₂/ |
| method] | (%) | (mmol/gSiO₂) | (mmol/gSiO₂) | mmol N) |
| 60% Ph-3-ED/ | 0 | 0.83 | 1.6 | 0.1 |
| SBA-15 | 30 | 2.73 | 2.9 | 0.17 |
| [Fixed bed] | | | | |
| 60% Ph-3-ED/ | 0 | — | 1.9 | 0.11 |
| SBA-15 | | | | |
| [TGA] | | | | |
| 60% | 0 | — | 2.25 | 0.18 |
| PEI/Mesoporous | 80 | — | 2.58 | 0.2 |
| Carbon | | | | |
| [Fixed bed]^{A} | | | | |

^{A}The CO₂ capacity and amine efficiency of 60% PEI (600)/mesoporous carbon are adopted from Wang et al. (adsorption conditions: 25° C., 400 ppm CO₂/N₂, flow rate of 50 mL/min, RH = 80%).⁵²_{[KDR3]}

### CONCLUSIONS

Composite materials made of alkyl-aryl amine small molecules (Ph-XX-YY) and porous substrates (SBA-15 and γ-alumina) were examined with a handful of techniques to determine their performance as sorbents for CO₂ adsorption. Given the characteristics of each substrate, the largest amount of CO₂ was adsorbed by 60% Ph-3-ED/SBA-15 and 50% Ph-3-ED/γ-Al₂O₃. In the case of using a silica SBA-15 support, the largest amount of CO₂ was captured by 60% Ph-3-ED/SBA-15, 50% Ph-3-PD/SBA-15, 50% Ph-6-ED/SBA-15 and 50% Ph-6-PD/SBA-15. The amine efficiency values did not follow the same trend, likely due to pore clogging that hindered access of the CO₂ gas to all amine sites. The optimum organic loading that led to the highest amine efficiency was 40%. The 50% Ph-3-ED/γ-Al₂O₃ composite showed a slightly lower CO₂ adsorption capacity as compared to the 60% Ph-3-ED/SBA-15 material but higher than that of 50% loaded homologues.

The temperature-swing adsorption-desorption cycles revealed a stable working capacity for these composites demonstrating no significant deactivation. Subjected to accelerated oxidation treatment at elevated temperature (110° C.), the retained performance of the samples when compared to non-treated freshly made ones decreased to 22% (50% Ph-3-ED/SBA-15) and 10% (50% Ph-6-PD/SBA-15), respectively.

CO₂ capacities obtained for 60% Ph-3-ED/SBA-15 from both TGA and fixed bed methods under dry conditions showed similar performance. CO₂ adsorption under humid conditions with 30% relative humidity showed a significant, three-fold enhancement in the breakthrough CO₂ capacity and a two-fold increase in the breakthrough time as compared to dry conditions in the fixed bed._{[KDR4]}.

This study revealed that the structure of the two types of alkyl-aryl molecules was a key factor that dictated their properties towards CO₂ adsorption. Conceivably, the diminished CO₂ uptake performance observed for Ph-6-YY/SBA-15 samples when compared to that of Ph-3-YY/SBA-15 counterparts was due to the bulky molecular architecture of the Ph-6-YY amine sorbent. Yet, given their working capacity performance as well as their thermal stability, these Ph-XX-YY sorbents are appealing for integration into direct air capturing technology.

### APPENDIX I

TABLE A1
CO₂ Capacity Expressed in mmoles/g sorbent and mmoles/_{gSiO2}, Amine loading and
amine efficiency for Ph-3-ED, Ph-3-PD, Ph-6-ED, Ph-6-PD on SBA-15 and γ-Al₂O₃ composites of
different organic loadings.

| | | | | | | | | | Amine |
|---|---|---|---|---|---|---|---|---|---|
| | Cal. | TGA | BET | Total | | | | Amine | efficiency |
| | Organic | Organic | surface | pore | Pore | CO2 | CO2 | loading | (mmol |
| | loading | loading | area | volume | filling | capacity | capacity | (mmol N/ | CO2/ |
| Sample | (%) | (%) | (m²/gSiO2) | (cm³/gSiO2) | (%) | (mmol/g) | (mmol/gSiO2) | gSiO2) | mmol N) |
| SBA-15 | — | — | 700 | 0.96 | — | — | — | — | — |
| Ph-3- | 20 | 23 | 401 | 0.71 | 26 | 0.14 | 0.18 | 3.3 | 0.05 |
| ED/SB | 30 | 27 | 345 | 0.59 | 39 | 0.3 | 0.42 | 4.9 | 0.09 |
| A-15 | 40 | 37 | 241 | 0.41 | 57 | 0.6 | 0.96 | 7.34 | 0.13 |
| | 50 | 43 | 102 | 0.18 | 82 | 0.82 | 1.43 | 11 | 0.13 |
| | 60 | 51 | 8 | 0.01 | 97 | 0.92 | 1.9 | 16.7 | 0.11 |
| Ph-3- | 20 | 27 | 375 | 0.77 | 20 | 0.07 | 0.1 | 3.94 | 0.02 |
| PD/SB | 30 | 34 | 321 | 0.58 | 40 | 0.16 | 0.25 | 5.25 | 0.05 |
| A-15 | 40 | 43 | 204 | 0.37 | 61 | 0.41 | 0.72 | 8.22 | 0.09 |
| | 50 | 53 | 55 | 0.1 | 90 | 0.56 | 1.23 | 12.45 | 0.1 |
| Ph-6- | 20 | 24 | 367 | 0.63 | 34 | 0.16 | 0.22 | 4.54 | 0.05 |
| ED/SB | 30 | 32 | 249 | 0.43 | 55 | 0.38 | 0.55 | 7.5 | 0.075 |
| A-15 | 40 | 40 | 127 | 0.22 | 77 | 0.53 | 0.87 | 11.44 | 0.077 |
| | 50 | 49 | 28 | 0.06 | 94 | 0.41 | 0.8 | 16.7 | 0.048 |
| Ph-6- | 20 | 23 | 357 | 0.58 | 39 | 0.16 | 0.21 | 4.23 | 0.050 |
| PD/SB | 30 | 30 | 291 | 0.49 | 49 | 0.19 | 0.28 | 6.44 | 0.043 |
| A-15 | 40 | 40 | 163 | 0.30 | 69 | 0.27 | 0.46 | 10.02 | 0.046 |
| | 50 | 49 | 39 | 0.08 | 92 | 0.3 | 0.59 | 15.48 | 0.038 |
| Bare y- | — | — | 115 | 0.99 | 0 | — | — | — | — |
| Al₂O₃ | | | | | | | | | |
| 50% | 50 | 48 | 15 | 0.10 | 90 | 0.76 | 1.54 | 14.6 | 0.11 |
| Ph- | | | | | | | | | |
| 3-ED/γ- | | | | | | | | | |
| Al₂O₃ | | | | | | | | | |

### REFERENCES

(1) Bui, M.; Adjiman, C. S.; Bardow, A.; Anthony, E. J.; Boston, A.; Brown, S.; Fennell, P. S.; Fuss, S.; Galindo, A.; Hackett, L. A. et al. Carbon capture and storage (CCS): the way forward. Energy & Environmental Science 2018, II (5), 1062.
(2) Jones, C. W. CO2 Capture from Dilute Gases as a Component of Modern Global Carbon Management. Annual Review of Chemical and Biomolecular Engineering 2011,2(1), 31.
(3) Chaikittislip, W.; Lunn, J. D.; Shantz, D. F.; Jones, C. W. Poly(L-lysine) Brush-Mesoporous Silica Hybrid Material as a Biomolecule-Based Adsorbent for CO2 Capture from Simulated Flue Gas and Air. Chemistry—A European Journal 2011, 77 (38), 10556.
(4) Keith, D. W. Why capture CO2 from the atmosphere? Science 2009, 325 (5948), 1654.
(5) Sanz-Pérez, E. S.; Murdock, C. R.; Didas, S. A.; Jones, C. W. Direct Capture of CO2 from Ambient Air. Chemical Reviews 2016, 116 (19), 11840.
(6) Yu, C.-H.; Huang, C.-H.; Tan, C.-S. A Review of CO2 Capture by Absorption and Adsorption. Aerosol Air Qual. Res. 2012, 12 (5), 745.
(7) Zhao, M.; He, H.; Dai, C.; Wu, X.; Zhang, Y.; Huang, Y.; Gu, C. Micelle formation by amine-based CO2-responsive surfactant of imidazoline type in an aqueous solution. J. Mol. Liq. 2018, 268, 875.
(8) Wang, L.; Kamali Shahri, S. M.; Rioux, R. M. CO2 Capacity and Heat of Sorption on a Polyethylenimine-Impregnated Silica under Equilibrium and Transient Sorption Conditions. J. Phys. Chem. C 2018, I22 (21), 11442.
(9) Zhang, S.; He, L.-N. Capture and Fixation of CO2 Promoted by Guanidine Derivatives. Aust. J. Chem. 2014, 67(7), 980.
(10) Rochelle, G. T. Amine Scrubbing for CO<sub>2</sub> Capture. Science 2009, 325 (5948), 1652.
(11) Lee, J. J.; Yoo, C.-J.; Chen, C.-H.; Hayes, S. E.; Sievers, C.; Jones, C. W. Silica-Supported Sterically Hindered Amines for CO2 Capture. Langmuir 2018, 34 (41), 12279.
(12) Pang, S. H.; Lively, R. P.; Jones, C. W. Oxidatively-Stable Linear Poly(propylenimine)-Containing Adsorbents for CO2 Capture from Ultradilute Streams. Chem Sus Chem 2018, 77 (15), 2628.
(13) Sarazen, M. L.; Jones, C. W. Insights into Azetidine Polymerization for the Preparation of Poly(propylenimine)-Based CO2 Adsorbents. Macromolecules 2017, 50 (23), 9135.
(14) Liu, F.; Huang, K.; Yoo, C.-J.; Okonkwo, C.; Tao, D.-J.; Jones, C. W.; Dai, S. Facilely synthesized meso-macroporous polymer as support of poly(ethyleneimine) for highly efficient and selective capture of CO2. Chemical Engineering Journal 2017, 314, 466.
(15) Pang, S. H.; Lee, L.-C.; Sakwa-Novak, M. A.; Lively, R. P.; Jones, C. W. Design of Aminopolymer Structure to Enhance Performance and Stability of CO2 Sorbents: Poly(propylenimine) vs Poly(ethylenimine). Journal of the American Chemical Society 2017, I39 (10), 3627.
(16) Holewinski, A.; Sakwa-Novak, M. A.; Carrillo, J.-M. Y.; Potter, M. E.; Ellebracht, N.; Rother, G.; Sumpter, B. G.; Jones, C. W. Aminopolymer Mobility and Support Interactions in Silica-PEI Composites for CO2 Capture Applications: A Quasielastic Neutron Scattering Study. The Journal of Physical Chemistry B 2017, 12 I (27), 6721.
(17) Darunte, L. A.; Oetomo, A. D.; Walton, K. S.; Sholl, D. S.; Jones, C. W. Direct Air Capture of CO2 Using Amine Functionalized MIL-101(Cr). ACS Sustainable Chemistry & Engineering 2016, 4(10), 5761.
(18) Sakwa-Novak, M. A.; Yoo, C.-J.; Tan, S.; Rashidi, F.; Jones, C. W. Poly(ethylenimine)-Functionalized Monolithic Alumina Honeycomb Adsorbents for CO2 Capture from Air. Chem Sus Chem 2016, 9 (14), 1859.
(19) Carrillo, J.-M. Y.; Sakwa-Novak, M. A.; Holewinski, A.; Potter, M. E.; Rother, G.; Jones, C. W.; Sumpter, B. G. Unraveling the Dynamics of Aminopolymer/Silica Composites. Langmuir 2016, 32 (11), 2617.
(20) Sakwa-Novak, M. A.; Tan, S.; Jones, C. W. Role of Additives in Composite PEI/Oxide CO2 Adsorbents: Enhancement in the Amine Efficiency of Supported PEI by PEG in CO2 Capture from Simulated Ambient Air. ACS Appl. Mater. Interfaces 2015, 7 (44), 24748.
(21) Shimon, D.; Chen, C.-H.; Lee, J. J.; Didas, S. A.; Sievers, C.; Jones, C. W.; Hayes, S. E. 15N Solid State NMR Spectroscopic Study of Surface Amine Groups for Carbon Capture: 3-Aminopropylsilyl Grafted to SBA-15 Mesoporous Silica. Environmental Science & Technology 2018, 52 (3), 1488.
(22) Bali, S.; Leisen, J.; Foo, G. S.; Sievers, C.; Jones, C. W. Aminosilanes Grafted to Basic Alumina as CO2 Adsorbents—Role of Grafting Conditions on CO2 Adsorption Properties. Chem Sus Chem 2014, 7 (11), 3145.
(23) Liu, S.; Zhang, Y.; Jiang, H.; Wang, X.; Zhang, T.; Yao, Y. High CO2 adsorption by amino-modified bio-spherical cellulose nanofibres aerogels. Environmental Chemistry Letters 2018, 16(2), 605.
(24) Hicks, J. C.; Drese, J. H.; Fauth, D. J.; Gray, M. L.; Qi, G.; Jones, C. W. Designing Adsorbents for CO2 Capture from Flue Gas-Hyperbranched Aminosilicas Capable of Capturing CO2 Reversibly. Journal of the American Chemical Society 2008, 130 (10), 2902.
(25) Fasihi, M.; Efimova, O.; Breyer, C. Techno-economic assessment of CO2 direct air capture plants. Journal of Cleaner Production 2019, 224, 957.
(26) Yue, M. B.; Sun, L. B.; Cao, Y.; Wang, Y.; Wang, Z. J.; Zhu, J. H. Efficient CO2 Capturer Derived from As-Synthesized MCM-41 Modified with Amine. Chem. Eur. J. 2008, 14 (11), 3442.
(27) Yamada, H.; Chowdhury, F. A.; Fujiki, J.; Yogo, K. Enhancement Mechanism of the CO2 Adsorption-Desorption Efficiency of Silica-Supported Tetraethylenepentamine by Chemical Modification of Amino Groups. ACS Sustainable Chem. Eng. 2019, 7 (10), 9574.
(28) Wifong, W. C.; Gray, M. L.; Soong, I.; Kail, B. W., 2018.
(29) Choi, S.; Drese, J. H.; Chance, R. R.; Eisenberger, P. M.; Jones, C. W., 2010; Vol. U.S. Pat. No. 8,491,705B2.
(30) Chuang, S.; WO 2009/061470 A1 ed., 2009; Vol. WO 2009/061470 A1.
(31) Xu, X.; Song, C.; Andresen, J. M.; Miller, B. G.; Scaroni, A. W. Novel Polyethylenimine-Modified Mesoporous Molecular Sieve of MCM-41 Type as High-Capacity Adsorbent for CO2 Capture. Energy & Fuels 2002, 16 (6), 1463.
(32) Li, K.; Jiang, J.; Yan, F.; Tian, S.; Chen, X. The influence of polyethyleneimine type and molecular weight on the CO2 capture performance of PEI-nano silica adsorbents. Applied Energy 2014, I36, 750.
(33) Jones, C. W.; Hicks, J. C.; Fauth, D. J.; Gray, M. L., 2007.
(34) Zhang, H.; Goeppert, A.; Prakash, G. K. S.; Olah, G. Applicability of linear polyethylenimine supported on nano-silica for the adsorption of CO2 from various sources including dry air. RSC Advances 2015, 5 (65), 52550.
(35) Eisenberger, P. M., 2016.
(36) Wang, D.; Wang, X.; Song, C. Comparative Study of Molecular Basket Sorbents Consisting of Polyallylamine and Polyethylenimine Functionalized SBA-15 for CO2 Capture from Flue Gas. Chem Phys Chem 2017, 18 (22), 3163.
(37) Bali, S.; Chen, T. T.; Chaikittisilp, W.; Jones, C. W. Oxidative Stability of Amino Polymer-Alumina Hybrid Adsorbents for Carbon Dioxide Capture. Energy & Fuels 2013, 27(3), 1547.
(38) Alkhabbaz, M. A.; Khunsupat, R.; Jones, C. W. Guanidinylated poly(allylamine) supported on mesoporous silica for CO2 capture from flue gas. Fuel 2014, 727, 79.
(39) Pang, S. H.; Jones, C. W.; Lee, L.-C.; Sakwa-Novak, M. A.; Sarazen, M. L.
(40) Khunsupat, R.; Jones, C. W.; Bali, S., 2013.
(41) Mane, S.; Gao, Z.-Y.; Li, Y.-X.; Xue, D.-M.; Liu, X.-Q.; Sun, L.-B. Fabrication of microporous polymers for selective CO2 capture: the significant role of crosslinking and crosslinker length. Journal ofMaterials Chemistry A 2017, 5 (44), 23310.
(42) Puthiaraj, P.; Lee, Y.-R.; Ahn, W.-S. Microporous amine-functionalized aromatic polymers and their carbonized products for CO2 adsorption. Chemical Engineering Journal 2017, 379, 65.
(43) Lee, J. J.; Sievers, C.; Jones, C. W. Silica-Supported Hindered Aminopolymers for CO2 Capture. Industrial & Engineering Chemistry Research 2019, 58 (50), 22551.
(44) Lee, J. J.; Chen, C.-H.; Shimon, D.; Hayes, S. E.; Sievers, C.; Jones, C. W. Effect of Humidity on the CO2 Adsorption of Tertiary Amine Grafted SBA-15. The Journal of Physical Chemistry C 2017, 727 (42), 23480.
(45) Li, Q.; Mu, X.; Xiao, S.; Wang, C.; Chen, Y.; Yuan, X. Porous aromatic networks with amine linkers for adsorption of hydroxylated aromatic hydrocarbons. J. Appl. Polym. Set. 2019, 136(2), 46919.
(46) Carrillo, J.-M. Y.; Potter, M. E.; Sakwa-Novak, M. A.; Pang, S. H.; Jones, C. W.; Sumpter, B. G. Linking Silica Support Morphology to the Dynamics of Aminopolymers in Composites. Langmuir 2017, 33 (22), 5412.
(47) Didas, S. A.; Choi, S.; Chaikittisilp, W.; Jones, C. W. Amine-Oxide Hybrid Materials for CO2 Capture from Ambient Air. Acc. Chem. Res. 2015, 48 (10), 2680.
(48) Serna-Guerrero, R.; Sayari, A. Modeling adsorption of CO2 on amine-functionalized mesoporous silica. 2: Kinetics and breakthrough curves. Chemical Engineering Journal 2010, 161 (1), 182.
(49) Sayari, A.; Belmabkhout, Y. Stabilization of Amine-Containing CO2 Adsorbents: Dramatic Effect of Water Vapor. Journal of the American Chemical Society 2010, 132 (18), 6312.
(50) Didas, S. A.; Zhu, R.; Brunelli, N. A.; Sholl, D. S.; Jones, C. W. Thermal, Oxidative and CO2 Induced Degradation of Primary Amines Used for CO2 Capture: Effect of Alkyl Linker on Stability. The Journal of Physical Chemistry C 2014, 118 (23), 12302.
(51) Chen, C.-H.; Shimon, D.; Lee, J. J.; Mentink-Vigier, F.; Hung, I.; Sievers, C.; Jones, C. W.; Hayes, S. E. The “Missing” Bicarbonate in CO2 Chemisorption Reactions on Solid Amine Sorbents. Journal of the American Chemical Society 2018, 140 (28), 8648.
(52) Wang, J.; Huang, H.; Wang, M.; Yao, L.; Qiao, W.; Long, D.; Ling, L. Direct Capture of Low-Concentration CO2 on Mesoporous Carbon-Supported Solid Amine Adsorbents at Ambient Temperature. Industrial & Engineering Chemistry Research 2015, 54 (19), 5319.

### Brief Technical Description

Alkyl-aryl amine rich molecules (Ph-XX-YY) impregnated into various porous substrates were examined for potential use as sorbents for CO2 capture from dilute and ultra-dilute gas streams such as flue gas and ambient air, respectively. Regardless of the substrate characteristics, the samples with the highest organic loadings (54%, 60%) captured the largest amount of CO2. The materials retained their good performance after temperature-swing absorption-desorption cycles and accelerated oxidation treatments.

Amine molecules or polymers supported on/in solid supports are known materials with diverse applications. Here we prepare a variety of composite materials made of alky-aryl molecules impregnated into solid supports that are thermally stable and show good CO2 adsorption performance in both dry and wet conditions. While solid-supported forms of other amine molecules and polymers are known, no materials like these have been reported for use in CO2 capture technologies.

Please provide a more detailed technical description.

Previously, and Global Thermostat have developed supported amine materials for CO2 capture from air. This is another invention developed with them, and is specifically a companion filing for the related composition of matter disclosure. This is an application disclosure. Supported amine materials are effective for extraction of CO2 from air.

These new materials offer potential advantages in that they pack in the pores of the supports different from conventional amine polymers. These materials perform close to the state of the art in CO2 capture from air, and the team has hypothesized ways to improve performance to surpass the state-of-the-art. Similar composite materials combining aryl-alkylamine molecules in porous oxide supports for CO2 capture are not known.

The study describes the use of alkyl-aryl amine reach molecules (Ph-XX-YY) as sorbents for capturing CO2 from dilute and ultra-dilute mixtures. These amines were impregnated into solid supports of various chemical compositions such as SBA-15, and γ-alumina. The organic loading of the composite Ph-XX-YY-based supports was in the 20%-60% mass range. In the case of each substrate, the high amine-loading samples (50%-60%) absorbed the largest amount of CO2 (using 400 ppm streams, at 35° C.). For example, the CO2 absorption capacity of 60% Ph-3-ED/SBA-15 was 1.9 mmol CO2/gSiO2, those of 50% Ph-3-PD/SBA-15 and 50% Ph-6-ED/SBA-15 were 1.23 mmol CO2/gSiO2 and 0.08 mmol PD/SBA-15 material exhibited the highest amine efficiency, 0.1 mmol CO2/mmol N. Intermediate organic loading (aka 40%) gave better performance in terms of amine efficiency: 0.13 versus 0.11 mmol CO2/mmol N for Ph-3-ED/SBA-15 (40%, 50%). Interestingly, in the case of Ph-6-PD/SBA-15 the amine efficiency flattened to an average value of 0.04 mmol CO2/mmol N. Overall, the PH 3-YY/SBA-15 composites showed a higher CO2 uptake performance than the PH-6-YY/SBA-15 homologues. This trend was also evident from the shape of the kinetic adsorption curves. These curves consisted of two distinct regions: one abruptly linear corresponding to the initial uptake that ‘curved’ to the other almost flat, referred to as the pseudo-equilibrium region, which asymptotically approaches the true equilibrium uptake. The highly concentrated samples approached the asymptotic regime of the curve the fastest, behavior associated with their fastest CO2 uptake. The pseudo-equilibrium region was then more drawn out, approaching the true equilibrium more gradually. The exception was the 50% and 40% Ph-6-ED/SBA-15 samples that displayed slower kinetic behavior than the intermediate and low concentration ones in the initial linear regime. These data together suggest that the bulky molecular geometry of Ph-6-YY may hamper Ph-6-YY/SBA-15 composites from performing similarly to the Ph-3-YY/SBA-15 counterparts, despite their higher amine content. In addition, their packing at the pore walls and within the supports together with the confinement characteristics adds to the complex landscape of interactions that govern the properties of these materials.

In order to examine the effect of the solid substrate on CO2 adsorption performance, a 50% Ph-3-ED/γ-Al2O3 composite was prepared. After TGA and N2 physisorption measurements confirmed successful impregnation of Ph-3-ED, the measured CO2 adsorption capacity was 1.54 mmol CO2/g γ-Al2O3 and the amine efficiency was 0.11 mmol CO2/mmol N. The CO2 uptake of this sample was higher than that of the similarly concentrated samples (50%) prepared using the SBA-15 support.

Because the high organic loading samples were the best performers in terms of CO2 uptake, they were further subjected to temperature-swing adsorption-desorption cycles and accelerated oxidation treatments. After 25 cycles of 1 h adsorption of 400 ppm CO2 (35° C.) followed by 10 min desorption in He (90° C.), 60% Ph-3-ED/SBA-15 retained up to 82% of its initial amine efficiency and 50% Ph-3-PD/SBA-14 retained 44.5% of the amine efficiency, with respect to the full uptake values recorded for 12 h of adsorption time in the absence of temperature-swing cycles. This value was lower for 50% Ph-6-ED/SBA-15 (40%) and 50% Ph-6-PD/SBA-15 (25%). One of the most important findings revealed by these experiments was the ability of all composites to maintain a stable working capacity, regardless of the trends in amine efficiency. The retained amine efficiency values were reduced when the best performing composite, Ph-3-YY/SBA-15, was exposed to 21% 02/He for 24 h at elevated temperatures (90° C. and 110° C.). The interactions with oxygen molecules caused diminished performance: only 39% (50% Ph-3-ED/SBA-15) and 20% (50% Ph-3-PD/SBA-15) of the original amine efficiencies were retained at 90° C. At 110° C. the values were 20% and 13%, respectively. These data confirm the idea that a bulky molecular architecture of Ph-6-YY did not favor high CO2 adsorption performance. Given their demonstrated properties, Ph-3-YY/SBA-15 composites, especially Ph-3-YY/SBA-15, are promising materials that can be potentially integrated into the DAC and other CO2 adsorption technologies.

What are the commercial applications for the invention?

The capture of acid gases from gas mixtures, including (CO2, S)2, NO, NO2, H2S, etc.).

Global Thermostat has an interest in CO2 and they have developed these materials with us for this purpose.

What are the advantages of the invention mover present technologies?

The composite materials with a high content of amine disclosed here have good thermal stability in the temperature interval with CO2 capture technologies operate. These materials display good adsorption performance in direct air CO2 capture both in dry and wet conditions.

1-3. (canceled)

4. A process the sorption of CO₂ from mixed gases ranging from 100 ppm-20% CO₂ concentration using composites of the organic molecule denoted Ph-3-PD supported on a porous or nonporous support material.

5-7. (canceled)

8. The process described in claim 4, with the preferred concentration range of 100-1000 ppm CO₂.

9. The process described in claim 3, with the preferred concentration range of 100-1000 ppm CO₂.

10. The process described in claim 4, with the preferred concentration range of 100-1000 ppm CO₂.

11. The process described in claim 3, with the preferred concentration range of 100-1000 ppm CO₂.

12. The process described in claim 4, with the preferred concentration range of 500 ppm-6% CO₂.

13. The process described in claim 3, with the preferred concentration range of 500 ppm-6% CO₂.

14. The process described in claim 4, with the preferred Ph-3-PD loading on the support material ranging from 20-70% wt.

15. The process described in claim 3, with the preferred Ph-3-ED loading on the support material ranging from 20-70% wt.

16-24. (canceled)
